(19) United States
(12) Patent Application Publication
(10) Pub. No.: US 2007/0188898 A1
(43) Pub. Date: Aug. 16, 2007

(54) Real Image Optical System

(75) Inventor: Stephen A. McClanahan, Tampa, FL (US)

Correspondence Address: SMITH HOPEN, PA, 180 PINE AVENUE NORTH, OLDSMAR, FL, 34677, US

(73) Assignee: UNIVERSITY OF SOUTH FLORIDA, Tampa, FL (US)

(21) Appl. No.: 11/625,065

(22) Filed: Jan. 19, 2007

Related U.S. Application Data
(60) Provisional application No. 60/766,437, filed on Jan. 19, 2006.

(51) Int. Cl. G02B 5/10

(52) U.S. Cl. 359/859

(57) ABSTRACT

An optical system for producing a three-dimensional real image of an object. The apparatus includes at least one concave reflective surface and a second reflective surface. In a first aspect of the invention the system includes two concave reflective surfaces in substantially fixed spatial relationship to each other. The surfaces share a common vertex. Furthermore, the tangential lines at the vertices of the reflective surfaces form an angle in the range of 90° to 180°. In a second aspect of the system one of the concave reflective surfaces is replaced by a planar reflective surface. By replacing a concave reflective surface with the planar reflective surface a three-dimensional real image can be created while achieving greater economy of production.

### CROSS REFERENCE TO RELATED APPLICATIONS

This application claims priority to currently pending U.S. Provisional Patent Application 60/766,437, entitled, “Simplified Method and Apparatus for Creating a Three-Dimensional Real Image Illusion”, filed Jan. 19, 2006, the contents of which are herein incorporated by reference.

### FIELD OF INVENTION

This invention relates to devices and methods for creating real images. More specifically, this invention relates devices and methods for creating three-dimensional real images using simplified optical systems and enhanced abilities to reproduce the desired image.

### BACKGROUND OF THE INVENTION

Methods for creating real three-dimensional illusions are known in the art. These methods generally rely on two concave or parabolic mirrors to create the resulting image. Using two concave mirrors to produce a real image of a physical object results in a projected image that is orthoscopic. The first concave mirror creates a pseudoptic image of the object. The pseudoptic image is then re-imaged by the second mirror to create an orthoscopic image.

U.S. Pat. No. 3,647,284 to Elings et. al. teaches an optical illusion device employing a pair of concave mirrors. The pair of concave mirrors are placed with their concave sides toward each other and one is optically apertured, either with a hole in the mirror or by an unsilvered portion in a mirror of transparent material. An object placed at the mirror that is not apertured will project a real image at the region of the aperture if the curvature and spacings of the mirrors are correct. One limitation of this device is that it has a very limited range in which the object to be imaged must be placed.

Other U.S. patents teaching the use of image systems include: U.S. Pat. No. 4,802,750 to Welck entitled “Real Image Projection System with Two Curved Reflectors of Paraboloid of Revolution Shape Having Each Vertex Coincident with the Focal Point of the Other”, U.S. Pat. No. 5,257,130 to Monroe entitled “Apparatus and Method for Creating a Real Image Illusion” and U.S. Pat. No. 6,568,818 B2 to Holden et. al. entitled “Three Dimensional Real Image System”. These subsequent teachings provide for a higher range over which the initial image may be placed and a respective larger range over which the projected image may be displayed. All of these rely on a combination of two concave spherical or parabolic mirrors. There is a need in the art to reduce the dependence on the two or more concave mirrors. The present invention fulfills this need as well as other needs that will become apparent to one of ordinary skill in the art through the teachings of the present disclosure.

### SUMMARY OF INVENTION

An optical system for producing a three-dimensional real image of an object. The apparatus includes at least one concave reflective surface and a second reflective surface. In a first aspect of the invention the system includes two concave reflective surfaces in substantially fixed spatial relationship to each other. The surfaces share a common vertex. Furthermore, the tangential lines at the vertices of the reflective surfaces form an angle in the range of 90° to 180°. In certain embodiments, the concave reflective surfaces have a shape selected from the group consisting of parabolic and spherical. The system can include a support member for affixing the optical system. Additionally, the support member can include a base for securely positioning the object. In certain embodiments the two concave reflective surfaces are concave spherical mirrors. In alternative embodiments the two concave reflective surfaces are concave parabolic mirrors. In certain embodiments the tangential lines at the vertex form an angle of 90°. The system can further include a light source for illuminating the object.

In a second aspect of the invention the system includes a concave reflective surface in substantially fixed spatial relationship to a flat reflective surface. The tangential lines at the vertex of the concave reflective surface forms an angle with the plane of the flat reflective surface in the range of 45° to 90°. The system can include a support member for affixing the optical system. Additionally, the support member can include a base for securely positioning the object. In certain embodiments the concave reflective surface is a concave spherical mirror. In alternative embodiments the concave reflective surface is a concave parabolic mirror. In certain embodiments the tangential line of the vertex of the concave reflective surface forms an angle with the plane of the flat reflective of 45°. The system can further include a light source for illuminating the object.

In a third aspect of the invention there is provided a system for focusing rays comprising of two concave surfaces sharing a common vertex whose tangential lines at the vertex create an angle of 90° with a focal point of r/4. The system can include a support member for affixing the optical system. In a fourth aspect there is provided an optical system composing of a curved segment rotated 360° capable of producing a reversed reflected image with a focal point of r/4.

Although the present invention is disclosed with reference to the optical characteristics, there are waves other than light that might benefit from the present invention. Much the same way that a concave mirror can focus entering parallel rays to a focal point (particularly useful in satellite dishes), the present invention also has the ability to focus parallel rays to its focal point. Therefore, additional applications would include those in the communication industry such as in the design of a satellite dish.

### BRIEF DESCRIPTION OF THE DRAWINGS

For a fuller understanding of the invention, reference should be made to the following detailed description, taken in connection with the accompanying drawings, in which:

FIG. 1 is a drawing illustrating the creation of a real, noninverted image. The concave mirrors intersect at their vertex and the angle formed between the tangential lines forms an angle θ, where θ in the range of 90° to 180°.

FIG. 2 is a drawing comparing the effect of a parabolic system compared to a pair of concave mirrors meeting at their vertex.

FIG. 3 is a drawing illustrating the image produced by the combination of a flat mirror and a concave mirror. In FIG. 3 a flat mirror has been added to the system depicted in FIG. 1 employing a pair of concave mirrors meeting at their vertex.

FIG. 4 is a drawing illustrating the creating of a real, noninverted image. The concave mirrors intersect at their vertex and the angle formed between the tangential lines forms an angle of 90° in the system depicted in the figure. FIG. 4 shows that a single object (solid arrow) results in the creation of two real images (dashed arrows) with the rays depicting the creation of the top of the image.

FIG. 5 is an alternative illustration of the device depicted in FIG. 4. FIG. 5 shows that a single object (solid arrow) results in the creation of two real images (dashed arrows) with the rays depicting the creation of the bottom of the image.

FIG. 6 is an illustration showing an optical system as depicted in FIGS. 4 and 5, with the addition of a flat mirror between the concave mirrors and the resulting image produced by the system.

FIG. 7 is an alternative illustration of the system depicted in FIG. 1, showing the effect on the image as the object is moved away (horizontally) from the mirror system.

FIG. 8 is an illustration of the system depicting the effect of lateral repositioning of the object and the resultant image produced.

FIG. 9 is an illustration depicting the real image produced by a pair of concave mirrors.

FIG. 10 is an illustration depicting an arc and an axis about which the arc is to be rotated to create a system or configuration capable of reversing the resulting real image.

FIG. 11 is an illustration depicting a side-view analysis of the system of FIG. 10.

FIG. 12 is an illustration depicting a top-view analysis of the system of FIG. 10.

FIG. 13 is an illustration depicting the real image produced by the system of FIG. 10.

FIG. 14 is an illustration depicting the convergence of rays produced by an object as it moves to infinity.

FIG. 15 is an additional illustration depicting the convergence of rays produced by an object as it moves to infinity.

FIG. 16 is an additional illustration depicting the convergence of rays produced by an object as it moves to infinity.

FIG. 17 is an embodiment of the invention displaying a real three dimensional image illusion.

FIG. 18 is an alternative view of the embodiment of the invention shown in FIG. 17. FIG. 18 presents a partial view of the embodiment of FIG. 17 showing the ray diagrams of the respective mirrors.

FIG. 19 is an alternative embodiment of the invention displaying a real three dimension image illusion of the object to the object. The object in the figure is depicted as a stick figure having a head whereby the head of the stick figure is displayed by operation of the mirrors as an illusory head in front of the figure.

FIG. 20 is an alternative view of the embodiment of the invention shown in FIG. 19. FIG. 20 presents a partial view of the embodiment of FIG. 19 showing the ray diagrams of the respective mirrors.

### DETAILED DESCRIPTION OF THE PREFERRED EMBODIMENT

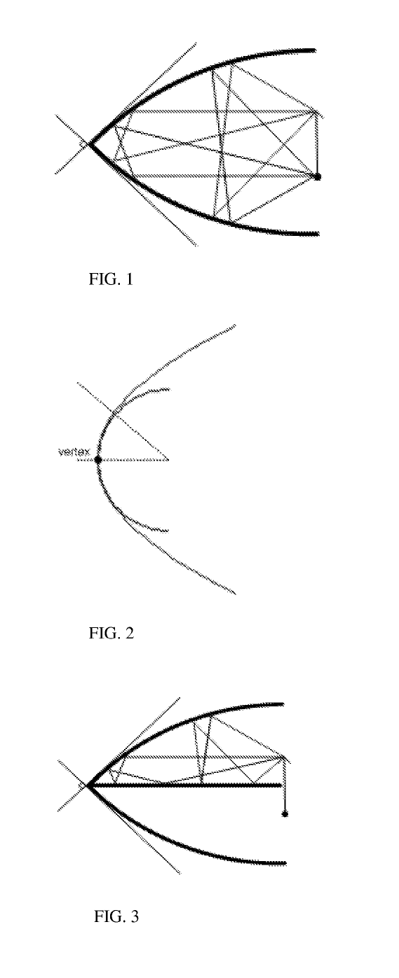

The present invention provides an optical system for producing a three-dimensional real image of an object. Referring to the drawings in general and FIG. 1 in particular, an exemplary embodiment according to the present invention is illustrated. When two concave mirrors, are placed together as shown in FIG. 1, a real non-inverted image is created. The tangent lines from both concave surfaces meet at their vertices to form an angle of 90°. Where the two tangent lines shown in FIG. 1 form 90°, both of the concave surfaces intersect. This intersection point is the vertex of both mirrors. The object and real image (line with arrow and ball heads in FIG. 1) are located a distance of r/2 from the vertices of the concave surfaces, where r is equal to the radius of the concave mirrored surfaces.

Since a circular arc approximates a parabola close to the vertex, see FIG. 2, both spherical and parabolic mirrors are acceptable for production of the optical system shown in FIG. 1. As such, the system has very minimal spherical aberration.

In FIG. 2, the spherical surface is shown by the lighted line, and the parabaloid is shown by the darker line. The area of the curved surfaces from the vertex to the second dotted line is the part of the curved surface used in the optical system shown in FIG. 1. Up to the point indicated by the dotted line there is very minimal difference between the parabolid and the spherical surface. This is a benefit for production of the optical system as the spherical surface is much easier and cheaper to produce than the parabolic surface.

The concave lines in FIG. 1 exhibit symmetry. This symmetry allows placement of a flat mirror along the horizontal axis along the path of symmetry. See FIG. 3 for an example of the same optical system in FIG. 1, but using a flat mirror instead of a second concave surface. Since it is much easier and cheaper to produce flat mirrors as opposed to spherical ones, the optical system in FIG. 3 might be becomes more practical from a cost perspective it eliminates one of the curved surfaces. However, note that in FIG. 3, the object image and real image are cut in half.

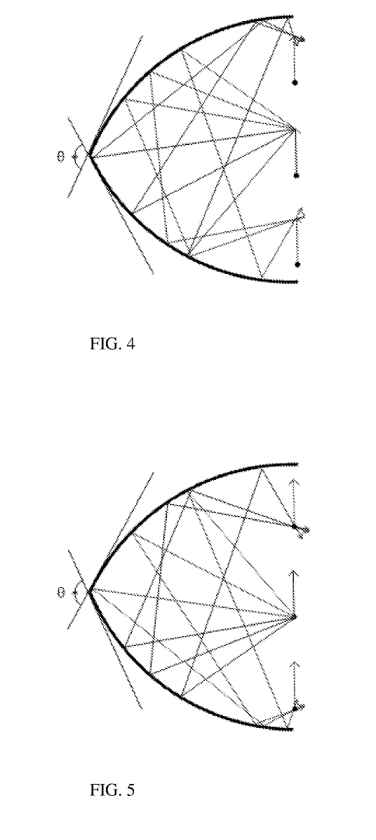

The tangential lines do not have to form 90° in order for a real image to form. The tangential lines can range from 90° to 180°. As soon as the tangential lines reach 180°, the two spherical surfaces become one large spherical surface, and are no longer capable of two reflections leading to an ortho-scopic real image. It takes two concave reflections to produce an ortho-scopic real image. The present invention includes not only mirror optical systems whose concave mirrors tangential lines at the vertex form 90°, but to those whose tangential lines also form angles between 90° and 180°. See FIG. 4 for an example of a mirror optical system using tangential lines when intersecting at the vertex form θ, where θ is greater than 90° and less than 180°.

The object image is shown as the solid line with an arrow at the top and a dot at the bottom. The real images are shown as the dotted lines with an arrow at the top and a dot at the bottom. Note that two real images are created. FIG. 4 shows how the top of the real images are formed. By symmetry, FIG. 5 shows how the bottom of the real images are formed. Combined, FIGS. 4 and 5 display how the optical system creates two real images located at vertical offsets from the object.

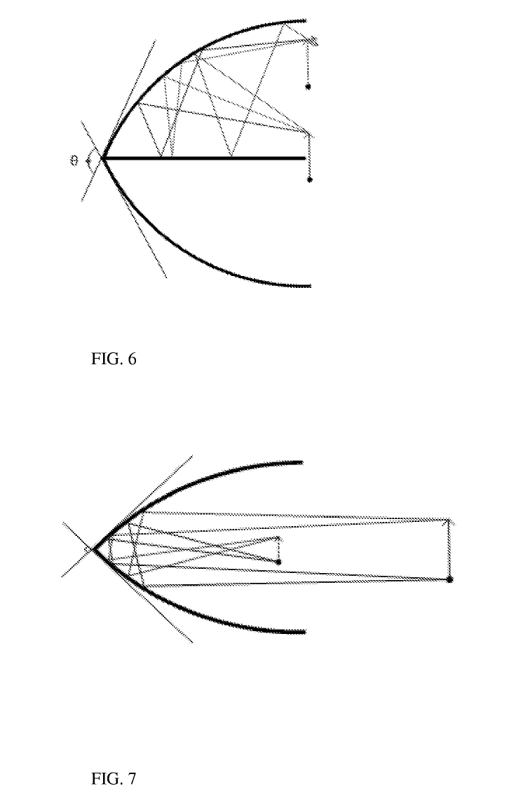

Note the symmetry in FIGS. 4 and 5. This symmetry allows a flat mirror to be placed along the plane of symmetry. FIG. 6 shows an example of the same optical system in FIGS. 4 and 5 but replacing one of the curved surfaces with a flat mirror.

As the object moves further away from the optical system, the real image forms closer and closer to the intersection of the vertices. Therefore, an optical system shown in FIG. 7 could be used to show to an object a real image of itself in front of itself. The further away the object is located, the smaller the real image becomes.

In FIG. 7, the object is shown as the solid line with the arrow at the top and a dot at the bottom. The real image is shown as the dotted line with the arrow at the top and a dot at the bottom. The alternative systems shown in FIGS. 3, 4, and 6 have the same properties. Unlike other previous optical systems, the present system allows objects to form real images from the points shown in FIGS. 1, 3, 4, and 6 to infinity.

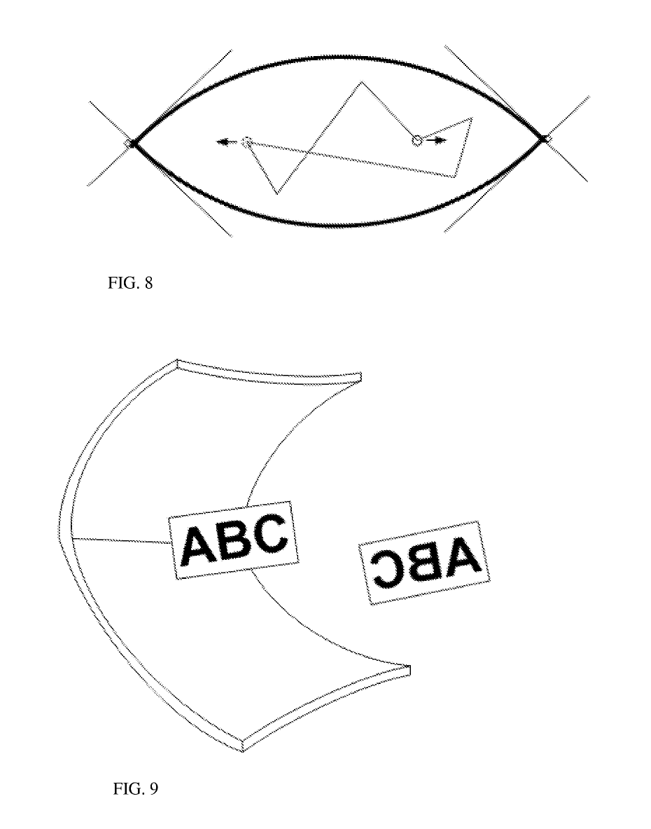

FIGS. 1 through 6 observe the optical systems from a vertical point of view (with respect to the object/real image). FIG. 7 is an observation when the object moves horizontally from the optical system. Since objects exist in three-dimensions, observation of the optical system as the object moves in and out of the page is further illustrative of the results of the system proposed. FIG. 8 is an example of the optical system of FIG. 1 when the object moves into the page. FIG. 8 is how the optical system in FIG. 1 looks from the point of view of the object. The rays in FIG. 8 move into the page while they propagate.

The circle on the right is the object, and the circle on the left is the real image produced. As the object moves to the right, the real image moves to the left. By similar reasoning, the alternative configurations shown in FIGS. 3, 4, and 6 have the same properties.

Therefore, up until now, the mirror configuration produces a reflected image to the object as it truly is, uninverted. Typical mirrors reverse the object (left becomes right and right becomes left). If text where to be held in front of the mirror configurations shown in FIG. 1 and FIG. 8, then the text would be reflected properly without reversing the reflected text, see FIG. 9. In FIG. 9, the text on the right is shown to the mirror in correct orientation (i.e. ABC), and the text on the left is the reflected text (minus the appropriate scale factor intentionally left out for this example) which displays the text in the same orientation as what is shown to the mirror (i.e. no left becomes right or right becomes left reversion in the reflected image).

In an alternative embodiment of the configurations presented thus far, the reflected image can display the reverse order of an object similar to typical mirrors. However, the reflected image would, much like the previous configurations, provide a real reflected image in front of the mirror, not behind it as with typical mirrors.

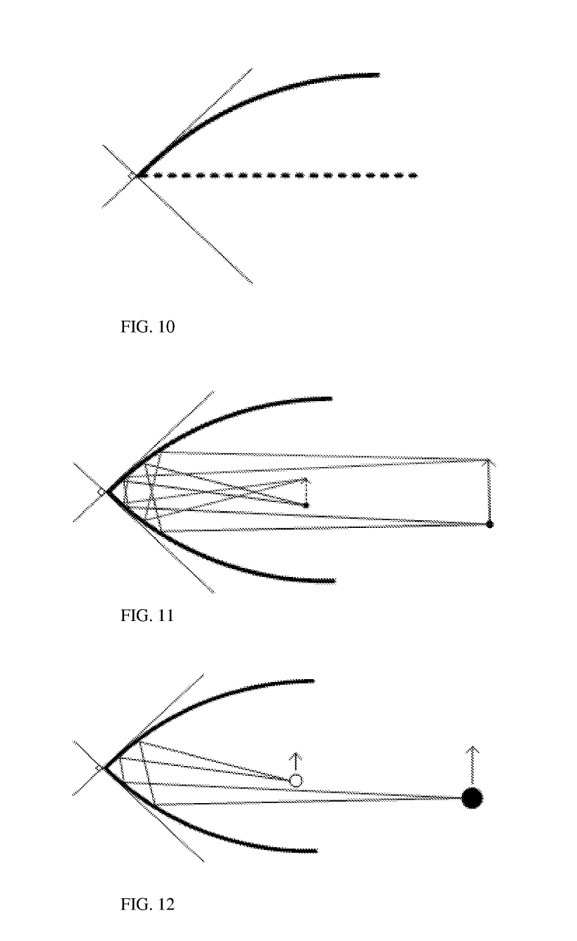

To accomplish this intended reversion (left becomes right), the configuration must not consist of two concave reflecting spheres. Instead taking the arc in FIG. 10 and rotating it about the dotted line 360 degrees would create a configuration capable of reversing the real image.

When inspecting the configuration described above from the side and from the top becomes indistinguishable from an optical point of view. See FIG. 11 for an example of a side view analysis. It is exactly the same as the analysis in FIG. 7.

See FIG. 12 for an example of a top view analysis. Note, that now when the object, right filled circle moves to the top, the real reflected image, left outlined circle, also moves to the top.

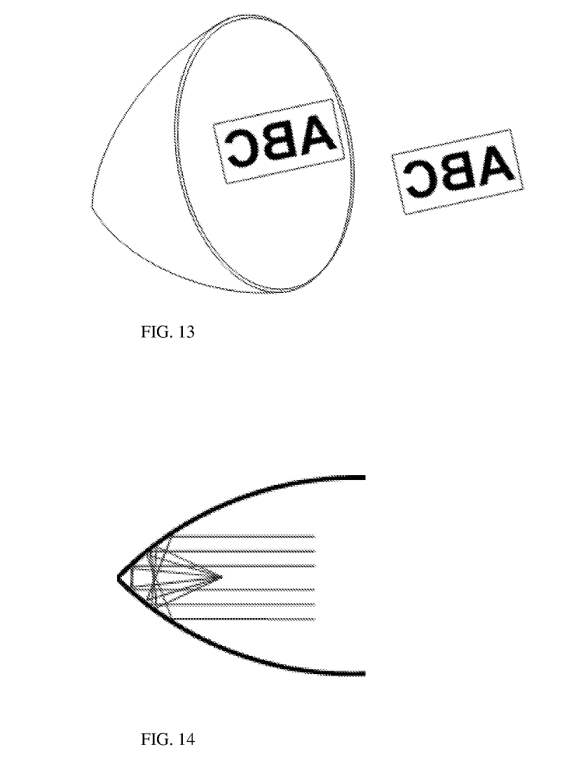

FIG. 13 is an example of how the above configuration reflects text.

Similar to the previous configuration where a flat mirror was placed along the axis of symmetry to create an alternative configuration, the similar analysis can be preformed in this second embodiment. Noting the axis of symmetry as shown in FIG. 10, a flat mirror or combination of flat mirrors can be placed along points of symmetry. A previous discussion of employing flat mirrors is sufficient to explain the similar use in this alternate configuration.

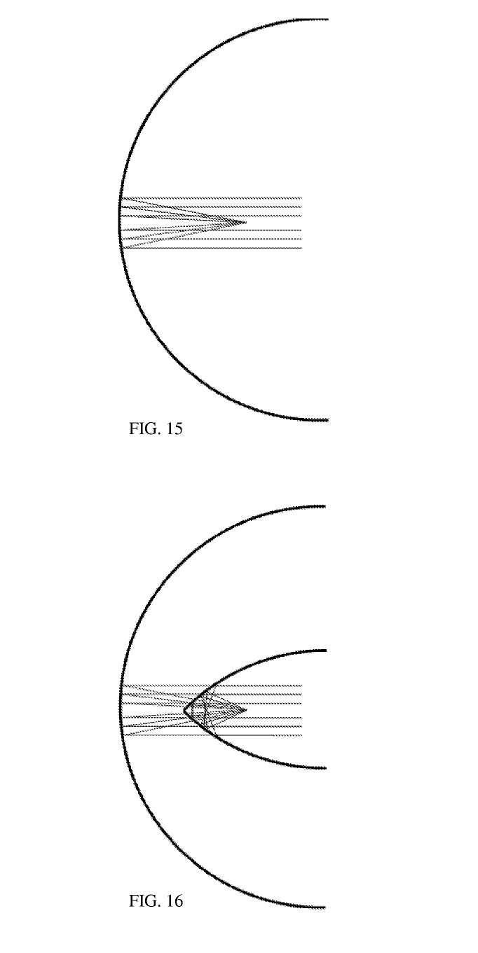

Note in FIG. 11 that as the object on the right moves farther and farther away from the vertices, the reflected real image becomes smaller and smaller. Eventually as the object moves to infinity, the reflected rays converge at a point. This point located a distance of r/4 from the vertices is the optical systems focal point, where r is equal to the radius of the curved arc shown in FIG. 10. See FIG. 14 for an example of the parallel rays reflecting to a single point.

Note that the reflected rays are reflected over two curved surfaces before converging at the focal point. This “double reflection” causes a focal point to form at a distance of r/4 from the vertices of the two curved surfaces, where r is the radius of each curved surface. This enables the configuration to be more compact than typical single reflecting curved surfaces. See FIG. 15 for an example of the same parallel rays entering a typical spherical/parabolic curved surface. Note that the reflected rays converge at a point r/2 from the vertex of the curved surface.

FIG. 16 is an overlay of FIG. 15 on FIG. 14. Note that the entering rays for both configurations are the same. The red lines form a focal point at r/2 where the blue lines form a focal point at r/4, where all the curved surfaces have the same radius r.

In order for this proposed configuration to be utilized in satellite receiving technology, all the reflected rays must travel the same distance before converging at the focal point. This means the reflected rays would be in phase with each other.

It is a well-known fact that the reflection matrix for a concave mirror is equal to Eq. 1.

$$[ \begin{matrix}1 & 0 \\ 2 / r & 1\end{matrix} ] \qquad ( Eq . 1 )$$

The matrix for drift space is shown in Eq. 2.

$$[ \begin{matrix}1 & d \\ 0 & 1\end{matrix} ] \qquad ( Eq . 2 )$$

Using these matrixes to descript the proposed optical system results in Eq 3.

$$[ \begin{matrix}1 & i \\ 0 & 1\end{matrix} ] [ \begin{matrix}1 & 0 \\ 2 / r & 1\end{matrix} ] [ \begin{matrix}1 & 0 \\ 0 & 1\end{matrix} ] [ \begin{matrix}1 & 0 \\ 2 / r & 1\end{matrix} ] [ \begin{matrix}1 & d \\ 0 & 1\end{matrix} ] \qquad ( Eq . 3 )$$

In Eq. 3, d is the distance of the object from the vertex of the optical configurations, and i is the distance of the reflected image to the vertex of the optical configuration. Eq 3 when solved and simplified equals in Eq. 4.

$$[ \begin{matrix}1 + \frac{4 i}{r} & i + d ( 1 + \frac{4 i}{r} ) \\ \frac{4}{r} & 1 + \frac{4 d}{r}\end{matrix} ] \qquad ( Eq . 4 )$$

When the A and B matrix terms become 0 is when the real image focus to a point, the focal point. Solving for the matrix A term is straight-forward and leads to a value of i=−r/4. When this value is inserted into the matrix B term and solved for zero, the result is d=1/0 or infinity. Truly when parallel rays enter the optical configuration from infinity, they converge at the focal point a distance of r/4 from the vertices of the optical configuration.

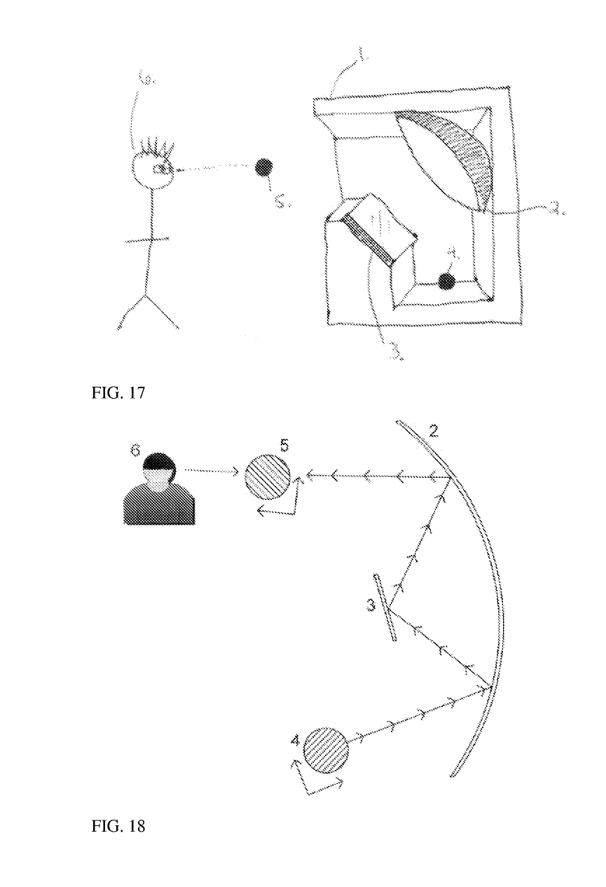

Referring now to FIG. 17 there is shown a cutaway view of an embodiment of the invention. The apparatus 1 includes a concave spherical mirror 2 and a flat mirror 3. The mirrors (2 and 3) are enclosed within the apparatus 1, whereby the apparatus functions as a frame to hold the mirrors in the proper placement with respect to one another and with respect to the object to be projected as the three-dimensional real image illusion. The flat mirror is placed at a distance of one-half the focal length of the concave mirror, the distance being with respect to the distance from the concave mirror. When an object 4 is appropriately placed just outside the focal length of the concave spherical mirror 2, within the frame 1, a real three-dimensional image illusion 5 will be seen by an observer 6.

Referring now to FIG. 18, a detailed drawing of the optics used to produce the image 5 is presented. Ray diagrams are used to display the path through which the image travels to the observer 6 creating the illusion 5 as the observer looks into the apparatus 1. One of ordinary skill in the art would easily be able to adjust the angle of the flat mirror with respect to the concave mirror to create variations of the location where the projected image would be displayed. Adjustment of this angle can also be made to maximize the clarity of the image illusion.

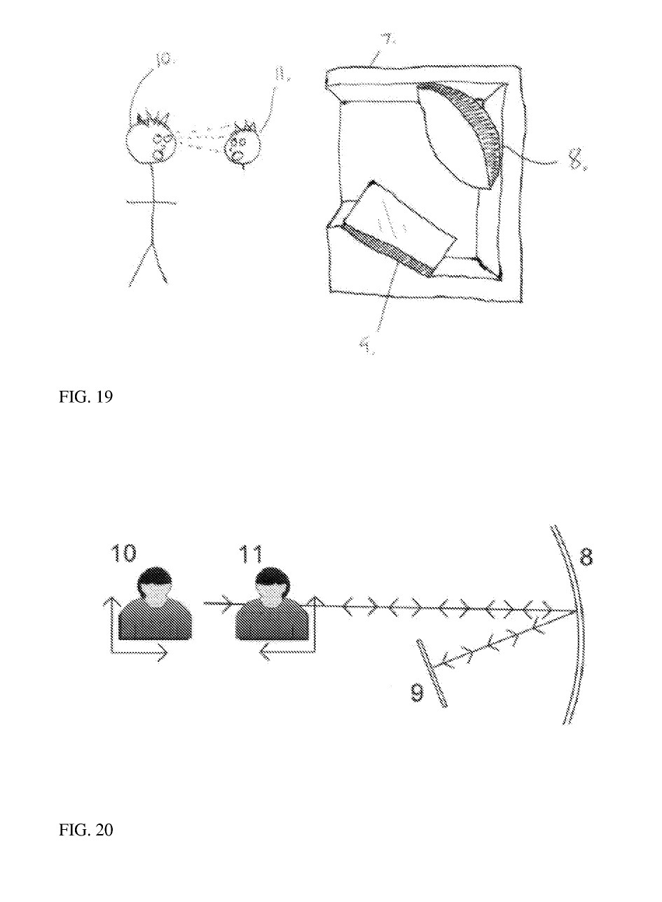

Turning now to FIG. 19, an alternate embodiment of the invention is presented. In FIG. 3, the observer 10 views a real image illusion of himself 11. The apparatus 7 of FIG. 3 is similar to the apparatus 1 of FIG. 1. The apparatus 7 provides a frame structure for supporting the flat mirror 9 and concave spherical mirror 8. The flat mirror 9 is placed a distance of one-half the focal length of the concave spherical mirror 8. When an observer 10 is placed just outside the focal length of the concave mirror, a real three-dimensional illusion 11 of the observer 10 is created.

Referring now to FIG. 20, a detailed illustration of the optics used to produce the image 11 is presented. Ray diagrams are used to display the path through which the image travels to the observer 10 creating the illusion 11 as the observer looks into the apparatus 7. Light travels from the observer 10 to the concave spherical mirror 8 and to the flat mirror 9. The light is reflected back along the same path to form the image illusion 11 perceived by the observer 10. One of ordinary skill in the art would easily be able to adjust the angle of the flat mirror with respect to the concave mirror to create variations of the location where the projected image would be displayed. Adjustment of this angle can also be made to maximize the clarity of the image illusion.

The disclosure of all publications cited above are expressly incorporated herein by reference, each in its entirety, to the same extent as if each were incorporated by reference individually.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. An optical system for producing a three-dimensional real image of an object, the system comprising two concave reflective surfaces in substantially fixed spatial relationship to each other wherein the surfaces share a common vertex and the tangential lines at the vertex form an angle in the range of 90° to 180°.

2. The optical system according to claim 1 wherein the concave reflective surfaces have a shape selected from the group consisting of parabolic and spherical.

3. The optical system according to claim 1 further comprising a support member for affixing the optical system.

4. The optical system according to claim 3 wherein the support member includes a base for securely positioning the object.

5. The optical system according to claim 1 wherein the two concave reflective surfaces are concave spherical mirrors.

6. The optical system according to claim 1 wherein the two concave reflective surfaces are concave parabolic mirrors.

7. The optical system according to claim 1 wherein the tangential lines at the vertex form an angle of 90°.

8. The optical system according to claim 1 further comprising a light source for illuminating the object.

9. An optical system for producing a three-dimensional real image of an object, the system comprising a concave reflective surface in substantially fixed spatial relationship to a flat reflective surface wherein the tangential lines at the vertex of the concave reflective surface forms an angle with the plane of the flat reflective surface in the range of 45° to 90°.

10. The optical system according to claim 9 further comprising a support member for affixing the optical system.

11. The optical system according to claim 10 wherein the support member includes a base for securely positioning the object.

12. The optical system according to claim 9 wherein the concave reflective surface is a concave spherical mirror.

13. The optical system according to claim 9 wherein the concave reflective surface is a concave parabolic mirror.

14. The optical system according to claim 1 wherein the tangential line of the vertex of the concave reflective surface forms an angle with the plane of the flat reflective of 45°.

15. The optical system according to claim 1 further comprising a light source for illuminating the object.

16. A system for focusing rays comprising of two concave surfaces sharing a common vertex whose tangential lines at the vertex create an angle of 90° with a focal point of r/4.

17. The optical system according to claim 9 further comprising a support member for affixing the optical system.
